(19) United States
(12) Patent Application Publication
(10) Pub. No.: US 2004/0207511 A1
(43) Pub. Date: Oct. 21, 2004

(54) System and method for securely activating a mechanism

(75) Inventor: John A. McEwan, Alexandria, VA (US)

Correspondence Address: NIXON PEABODY, LLP, 401 9TH STREET, NW, SUITE 900, WASHINGTON, DC, 20004-2128, US

(73) Assignee: TECHNOLOGY ADVANCEMENT GROUP, INC., Dulles, VA

(21) Appl. No.: 10/419,274

(22) Filed: Apr. 21, 2003

(51) Int. Cl. G06F 7/04

(52) U.S. Cl. 340/5.61

(57) ABSTRACT

A security system includes a first transceiver for transmitting a signal to a second transceiver when the first transceiver is proximate a protected device such as a door or an electronic device. When the signal is received and authenticated, and when a verification device is activated, security features related to the device are deactivated. The verification device is configured to be activated when a person takes natural actions to access the device to thereby obfuscate the verification process and to eliminate the need to train authorized users to use the system.

### BACKGROUND OF THE INVENTION

1. Field of the Invention

The invention relates generally to an activation system and more specifically to a system for activating a mechanism in a secure manner.

2. Description of the Related Art

There are many applications for which it is desirable to activate a mechanism in a secure manner. For example, a variety of electronic key systems for opening door latches or otherwise activating security disabling mechanisms and the like are known. Security systems utilizing magnetic card readers, keypads and various transmitter/receiver arrangements are known for identifying an authorized person and activating a door latch or otherwise disabling security features. Magnetic card readers and keypads generally offer minimal security or convenience improvements compared to conventional mechanical locks. The user still must enter a code in the keypad or swipe the card through a card reader to obtain entry.

Transmitter/receiver systems (known as “keyless” systems because they dispense with the need for a conventional key and lock mechanism) are somewhat more convenient. In particular, such systems activate security feature disabling mechanisms based on a signal from a transmitter to the receiver. For example, in the case of an automobile security system, a small radio frequency transmitter can be placed on the key chain of an authorized person and the person can press a button when approaching the automobile to transmit a signal to unlock the door and/or disable an alarm system. More recently, systems have been developed that provide access based solely on the proximity of a transmitter to the receiver of an access controller. Such systems do not require the authorized person to take any action other than to carry the transmitter. The security features are disabled when the person carrying the transmitter comes into close proximity with the receiver positioned proximate the door. For example U.S. Pat. No. 3,891,980 discloses a system in which an authorized person carries a transmitter. When the person is proximate the door, if the correct signals are being received by a receiver near the door, the door is unlocked automatically.

The proximity type of transmitter/receiver security system has become popular for use in activating security disabling mechanisms of automobiles and other vehicles. For example, U.S. Pat. No. 4,688,036 discloses a portable transmitter that transmits a radio frequency signal with a unique code that is detected by a controller in a vehicle. Vehicle functions are actuated by the controller when the unique code matches a preset code stored in the controller. Also, U.S. Pat. No. 4,942,393 discloses a system for unlocking and locking the doors of a vehicle as a person approaches or moves away from the vehicle. The system consists of a portable transmitter carried by the person and a receiver in the vehicle. A motion sensor is provided in the transmitter to conserve battery life by turning off the transmitter when it is still for a period of time.

Proximity type keyless entry systems have increased the convenience of keyless entry systems by eliminating the need for an authorized person to take any action to unlock a door, other than carrying the transmitter. However, conventional proximity type keyless entry systems have limitations. In particular, whenever the authorized person carrying the transmitter is proximate the door, the door will unlock and/or other security features will be disabled. For example, in the case of a vehicle security system, the door will unlock and lock as the authorized person with the transmitter moves around the vehicle during washing of the vehicle, maintenance of the vehicle, or otherwise remaining near the vehicle and moving in and out of the critical transmitter range, subject to any timing or logic restrictions of the system. Further, even when the transmitter stays within the critical range, the typical system will time out and lock the doors, only to open the doors again in response to proximity of the transmitter. This can be avoided by moving the transmitter to a remote place thus locking the doors and thus requiring the authorized person to locate and retrieve the transmitter to enter the vehicle. Alternatively, the transmitter can be placed within range of the receiver thus unlocking the doors. As noted above, most keyless systems will automatically lock the doors after the transmitter signal has been received for a predetermined period of time to avoid compromising security. This can cause a problem when the authorized person chooses to place the transmitter within the vehicle because the vehicle will eventually become locked with the transmitter inside the vehicle preventing even the authorized person from unlocking the vehicle. Similarly, some systems will place the transmitter in a power saving mode after a predetermined period in which the transmitter has not moved. This may result in locking of the vehicle after the predetermined period of nonmovement, such as when the user sets the transmitter at rest on a table or in the car.

U.S. Pat. No. 5,134,392 discloses a keyless entry system which conserves battery power of the transmitter by requiring an authorized user to activate a button on a vehicle exterior, to send an enabling signal to the transmitter, which can receive such a signal, in addition to bringing the transmitter in proximity to the receiver. However, this system requires that the authorized user take the additional unnatural action of activating the button prior to entering. Accordingly, this system, while reducing battery drain of the transmitter, has the disadvantages of the card and keypad systems discussed above in that this system requires additional unnatural actions by the user.

Security systems and the other activation systems have been applied to various mechanism, such as audio/video equipment, communications equipment, computer systems, safes, and the like. Further, activation systems can be used in combination for greater security. For example, some government agencies require three different elements for access. These could be a password (something you know) a token (something you possess) and a biometric parameter (something about you).

### BRIEF SUMMARY OF THE INVENTION

It is an object of the invention to permit activation of various mechanisms in a secure manner.

It is another object of the invention to render circumventing of an activation system complex by obfuscating the verification process.

It is another object of the invention to render circumventing of an activation system complex by minimizing the time period in which activation signals are transmitted.

It is another object of the invention to reduce the need for any unnatural action by an authorized person when activating a mechanism and thus significantly reducing or eliminating the need for training authorized persons while maintaining security.

In order to achieve these objects, a first aspect of the invention is a system for securely activating a mechanism. The system comprises a first unit and a second unit configured to transmit a signal therebetween over a predetermined distance, a verification device associated with the mechanism and being operatively coupled to the mechanism to be activated when natural actions are taken to operate the mechanism, and a deactivation device configured to deactivate security features of the mechanism when the signal is received and the verification device is activated.

A second aspect of the invention is a security system for controlling access through a door comprising, a first unit and a second unit configured to transmit a signal therebetween over a predetermined distance, a verification device associated with the door and configured to be activated when natural actions are taken to open the door, a door security mechanism, and a deactivation device configured to deactivate the door security mechanism when the signal is received and the verification device is activated.

### BRIEF DESCRIPTION OF THE DRAWING

The invention is described through a preferred embodiment and the attached drawing in which:

FIG. 1 is a block diagram of a security system of the preferred embodiment;

FIG. 2 is a block diagram of the first transceiver of FIG. 1; and

FIG. 3 is a block diagram of the second transceiver of FIG. 1.

### DETAILED DESCRIPTION OF THE PREFERRED EMBODIMENT

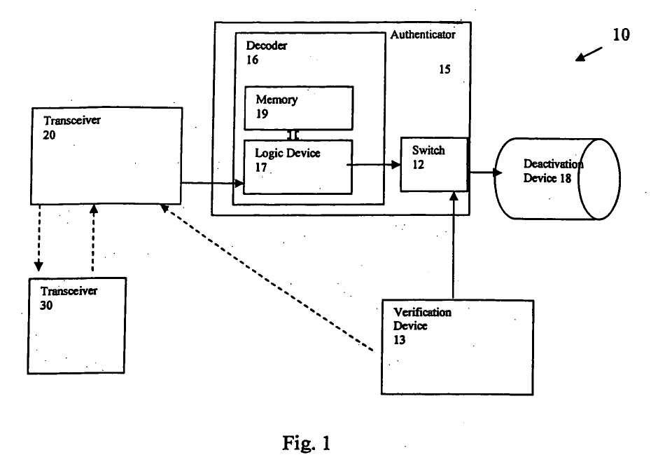

FIG. 1 illustrates a preferred embodiment of the invention suitable for use as a security system. Security system 10 includes transceiver 20 and authenticator 15 coupled to an output of transceiver 20 and operative to authenticate a code signal received by transceiver 20 as described below. Authenticator 15 outputs a deactivation signal when a code signal is authenticated. Further, the output of authenticator 15 is coupled to deactivation device 18, such as a solenoid coupled to a door lock or door latch (not illustrated). Authenticator 15 comprises decoder 16 and switch 12. Switch 12 can take the form of an electromechanical relay, a solid state switch device, such as a silicon controlled rectifier (SCR), or any other device capable of selectively coupling the output of decoder 16 to deactivation device 18 in a physical or logical manner. For example, switch 12 can be a logical AND gate which only permits a signal from decoder 16 to be affective when verification device 13 is activated. This operation is described in greater detail below. Preferably, transceiver 20, decoder 16, switch 12, verification device 13, and deactivation device 18 are located proximate the entrance to be protected. Portable transceiver 30 can be carried by the person authorized to access to the door. For example, transceiver 30 can be of a size to be carried on a key chain of the authorized user. Note that transceiver 30 and transceiver 20 of the preferred embodiment are units operative to communicate with one another in one or more of various ways. Accordingly, each unit can be a transceiver, a transmitter, or a receiver.

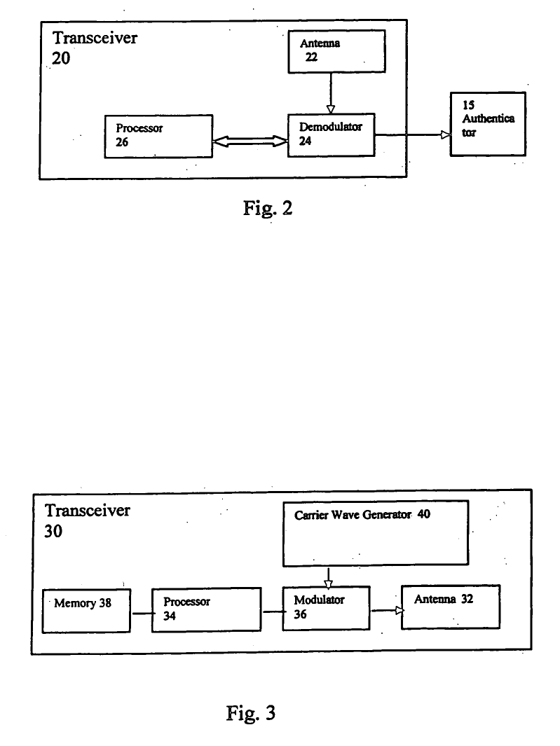

FIG. 2 illustrates transceiver 20 in greater detail. Transceiver 20 includes demodulator 24 which serves to demodulate the code signal transmitted by transceiver 30 and received through antenna 22. A demodulated output signal of demodulator 24 is indicative of the code stored in memory 38 of transceiver 30 and is output to decoder 16 of authenticator 15 (see FIG. 1). Processor 26 serves to coordinate the functions of transceiver 20 in accordance with a preprogrammed control program. For example, processor 26 can be a field programmable gate array (FPGA) or other solid state or hardwired logic device.

FIG. 3 illustrates transceiver 30 of the preferred embodiment in greater detail. Processor 34 serves to coordinate the functions of transceiver 30 in accordance with a preprogrammed control program. For example, processor 34 can be a field programmable gate array (FPGA) or other solid state or hardwired logic device. Memory 38 is coupled to processor 34 and stores a preset code for identifying transceiver 30. Processor 34 reads the preset code out of memory 38, transfers the code to modulator 36 which is in turn coupled to carrier-wave generator 40. Modulator 36 modulates a carrier-wave generated by carrier wave generator 40 with the code from memory 38 to produce a code signal that is transmitted by antenna 32 of transceiver 30. The code signal can be transmitted periodically, only in response to a signal indicating proximity to transceiver 20, constantly, in response to motion, a combination of these methods, in response to a triggering signal, or in any other manner. The code signal can be transmitted using known radio frequency methods, bandwidths, and communication protocols. The triggering signal can be generated by transceiver 20 in response to activation of verification device 13 or in any other manner. The triggering signal can be coded to prevent unauthorized triggering of transceiver 30.

As illustrated in FIG. 1, decoder 16 includes memory 19 which stores an authentication code that corresponds to the code in memory 38. If the output of demodulator 24, which indicates the code in memory 38, corresponds to the authentication code stored in memory 19, logic device 17 of decoder 16 outputs the deactivation signal to switch 12. Logic device 17 can be any type of solid state or hardwired logic device.

Switch 12 is coupled to verification device 13 so that switch 12 is placed in a closed position, or otherwise couples the signal of decoder 16 in a physical or logical manner to deactivation device 18, when verification device 13 is operated. Accordingly, the deactivation signal will only be operative to energize deactivation device 18 when transceiver 30 having the proper code in memory 38 transmits a code signal from within a predetermined range of antenna 22 of transceiver 20 and verification device 13 is activated. Verification device 13 is associated with a security mechanism such as a door, an “on” switch or the like, so that natural actions for operating the mechanism will activate verification device 13. For example, verification device 13 can be a pressure sensitive, resistive, or capacitive touch sensor disposed on, or otherwise associated with, the handle of a door. Similarly, verification device 13 can be a switch that is operated when a door handle or door is moved through a natural movement for opening the door. As an example, verification device 13 can be a micro switch that is activated upon the natural action of moving a pivoting handle to open the door.

Further, verification device 13 can include a sensor for detecting presence of a person, such as a weight sensor, a heat sensor, a carbon dioxide sensor, a humidity sensor a light sensor (for detecting a reflection or shadow), an acoustic sensor (for detecting a change to a known acoustic pattern, for detecting a human voice, or for detecting other sounds indicating natural actions), a motion sensor, or a biometric sensor. Further, verification device 13 can include any type of sensor that verifies natural actions of access, such as presences of a person, presence of a person's hand or other body part, turning of a door handle, or the like. For example, verification device 13 can be a proximity sensor that detects when a persons hand is placed on the door handle. The phrase “natural action”, as used herein, refers to actions normally taken to operate the mechanism notwithstanding security system 10. Verification through natural actions makes it difficult for observers to ascertain the nature of the verification process and thus renders the security system difficult to crack. Also, such verification does not require behavioral modification, i.e. unnatural actions, of the user. Therefore, users do not have to be trained to use the system.

In response to receiving the deactivation signal, deactivation device 18 deactivates security features, such as unlocking a door and/or turning off an alarm, energizing equipment, or the like. Accordingly, the security features will only be deactivated when transceiver 20 receives the proper code signal and the authorized person takes natural actions to operate the mechanism. Therefore, the need to deactivate security features is verified and unwanted deactivation of security features is avoided.

The various components can be of any type to accomplish the functions described above. While the components are illustrated and described as discrete components for clarity, it will be apparent to one of skill in the art that the various components can be combined or segregated based on the specific application. For example, all or some components of the transceiver or the transceiver can be fabricated as a semiconductor device on a single substrate. The verification device can be of any type that permits the deactivation signal to operate the deactivation device when a person takes any natural action for operating the mechanism. The verification device can have an identifying feature for confirming the identity of the authorized person through biometrics or other information. For example, the verification device can be a fingerprint scanner disposed in or on a door handle and the processor of the transceiver can be programmed to confirm that the person grasping the handle is an authorized person based on a stored fingerprint signature. Alternatively, biometrics, such as face recognition or retinal scans can be used to generate the code signal. Verification can be accomplished fast enough to appear as if no security measures have been taken, unless unauthorized entry is attempted. Together with a keypad, this system will provide all three elements required by government agencies, i.e., something you know, something you possess, and something about you.

The transceivers can be units that communicate in any manner. For example, the code signal can be sent as infrared light pulses or microwaves. The code signal can be in any form that indicates presence of the transceiver and need not include a numerical code or other type of code. Further, the transceiver can be any device for communicating a code or other signal to the other transceiver. Accordingly, the term “transceiver” as used herein does not require an active device. Also, the transceiver can be an active device that reads a signal from the other transceiver. For example, one transceiver can be a smart tag or smart card device having a code programmed therein that can be read by the other transceiver when the other transceiver sends a signal. The transceiver can transmit an excitation signal and read a frequency modulated or other type of response from the other transceiver. The transceivers can be a chip or tag carried in a wallet, or pocket, attached to or embedded in clothes, rings, shoes, hats, or the like.

As noted above, the transceiver can be a physical property, such as a facial or retinal image, of the user and the other transceiver can be the appropriate biometric sensor. The invention can be applied to security systems for a vehicle or any other security systems in which access is to be granted selectively. For example, the invention can be applied to security systems for buildings, areas, cabinets, or the like. Also, the invention can be applied to secure operation of various equipment, such as a computer or audio/video equipment. The deactivation device can be a lock solenoid for opening or closing a lock or a door, or any other type of device that disable a security feature, such as disabling an alarm, for permitting or granting access. Instead of using a switch to selectively couple the deactivation signal to the deactivation device, the deactivation signal can be generated when the code signal is received from the transceiver and the verification device is activated.

The preferred embodiment can be operated in various modes. For example, authentication can be accomplished independently of verification, through proximity or other actions as described above, and verification can then be used to complete security deactivation. As another example, a positive verification can be used to “chirp”, i.e. trigger, the authentication device which then authenticates and completes security deactivation. As yet another example, the natural action can be used to trigger authentication and verification, in any order.

The invention can be applied to restricting use to electronic devices, such as computers and audio/video equipment. Verification can be conducted over and over again at predetermined intervals or in response to predetermined events. For example, when applying the invention to a remote control or other controls of electronic equipment, verification can be checked every time the user pushes a control button, such as a volume or channel selector.

One or both of the transceivers can be activated only in response to activation of the verification device to increase security by reducing the opportunity for eavesdroppers to duplicate the code signal. In particular, through the use of scanners and other security circumvention equipment unauthorized persons often are able to intercept, read, and duplicate security codes. In the preferred embodiment, if codes or other signals are only transmitted for brief periods of time, such as fractions of a second, when the verification device is activated, the opportunity for eavesdroppers to intercept the security code is minimized. In contrast, conventional devices transmit the security code in a substantially constant manner. Also, a “blackout” period can be used to prevent multiple transmissions in close succession to thereby render it difficult to scan or otherwise monitor the signal transmission. One or both of the transceivers can be portable and the other of the transceivers can be coupled to the activation device. Further, there can be plural authentication devices and/or processes and plural verification devices and/or processes.

In addition to controlling access to vehicles and electronic equipment, the invention can be applied to various security systems. For example, cabinets, closets, or other areas can be restricted from small children, guests, or others. Further, high security devices, such as safes, can be secured behind doors, or the like protected with the invention. For example, a painting can be configured to be a door obscuring a safe. Opening of the door can be restricted with the invention. Further, the invention can be applied to various security applications requiring various levels of security and complexity. For example, very simple and inexpensive systems can be configured for household closets, cabinets, and the like, and more complex and secure systems can be configured for higher security applications. For example, the invention can be easily implanted to effect NSA triple parameter applications.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A system for securely activating a mechanism, said system comprising:
a first unit and a second unit configured to transmit a signal therebetween over a predetermined distance;
a verification device associated with the mechanism and being operatively coupled to the mechanism to be activated when natural actions are taken to operate the mechanism; and
a deactivation device configured to deactivate security features of the mechanism when the signal is received and the verification device is activated.

2. A system as recited in claim 1, wherein said verification device is operatively coupled to at least one of said first unit and said second unit to cause the signal to be transmitted only when said verification device is activated.

3. A system as recited in claim 1, wherein said verification device is independent of said first unit and said second unit to permit the signal to be transmitted at any time.

4. A system as recited in claim 1, wherein said first unit is a transmitter and said second unit is a receiver.

5. A system as recited in claim 1, wherein said second unit is a transmitter and said first unit is a receiver.

6. A system as recited in claim 1, wherein said first unit and said second unit are each transceivers.

7. A system as recited in claim 1, wherein the mechanism is a door security mechanism.

8. A system as recited in claim 1, wherein the mechanism is a door lock.

9. A system as recited in claim 1, wherein the mechanism is a door alarm.

10. A system as recited in claim 1, wherein the mechanism is an activation mechanism for electronic equipment.

11. A system as recited in claim 1, wherein said verification device comprises a switch.

12. A system as recited in claim 1, wherein said verification device comprises a chemical sensor.

13. A system as recited in claim 12, wherein said chemical sensor is one of an odor sensor, a gas sensor, and an element sensor.

14. A system as recited in claim 1, wherein said verification device comprises a proximity sensor.

15. A system as recited in claim 14, wherein said proximity sensor is one of a touch sensor, a weight sensor, a humidity sensor, a light sensor, a camera, an acoustic sensor, a heat sensor, a pressure sensor, a motion sensor and a vibration sensor.

16. A system as recited in claim 1, wherein said verification device comprises a biometric sensor.

17. A system as recited in claim 1, wherein said verification device comprises one of a magnetic field sensor, and electric field sensor, a resistive sensor, a capacitive sensor, and an inductive sensor.

18. A system as recited in claim 1, wherein said first unit is a passive device and said second unit is operative to generate an excitation signal which causes said first unit to generate the signal.

19. A system as recited in claim 1, wherein said first unit is a physical characteristic of a user and said second unit comprises a biometric sensor.

20. A system for controlling access through a door comprising:
a first unit and a second unit configured to transmit a signal therebetween over a predetermined distance;
a verification device associated with the door and configured to be activated when natural actions are taken to open the door; a door security mechanism; and
a deactivation device configured to deactivate said door security mechanism when the signal is received and said verification device is activated.

21. A system as recited in claim 20, wherein said verification device is operatively coupled to at least one of said first unit and said second unit to cause the signal to be transmitted only when said verification device is activated.

22 A system as recited in claim 20, wherein said verification device is independent of said first unit and said second unit to permit the signal to be transmitted at any time.

23. A system as recited in claim 20, wherein said first unit is a transmitter and said second unit is a receiver.

24. A system as recited in claim 20 wherein said second unit is a transmitter and said first unit is a receiver.

25. A system as recited in claim 20, wherein said first unit and said second unit are each transceivers.

26. A system as recited in claim 20, wherein said door security mechanism is a door lock mechanism.

27. A system as recited in claim 20, wherein said door security mechanism is an alarm mechanism.

28. A system as recited in claim 20, wherein said verification device comprises a switch.

29. A security system as recited in claim 20, wherein said verification device comprises a touch sensor disposed on a handle of the door.

30. A security system as recited in claim 20 wherein said verification device comprises a switch coupled to a moveable handle of the door.

31. A security system as recited in claim 20, wherein said verification device comprises a proximity sensor disposed proximate a handle of the door.

32. A system as recited in claim 20, wherein said verification device comprises a chemical sensor.

33. A system as recited in claim 32, wherein said chemical sensor is one of an odor sensor, a gas sensor, and an element sensor.

34. A system as recited in claim 20, wherein said verification device comprises a proximity sensor.

35. A system as recited in claim 34, wherein said proximity sensor is one of a touch sensor, a weight sensor, a humidity sensor, a light sensor, a camera, an acoustic sensor, a heat sensor, a pressure sensor, a motion sensor and a vibration sensor.

36. A system as recited in claim 20, wherein said verification device comprises a biometric sensor.

37. A system as recited in claim 20, wherein said verification device comprises one of a magnetic field sensor, and electric field sensor, a resistive sensor, a capacitive sensor, and an inductive sensor.

38. A security system as recited in claim 20, wherein said first unit is a passive device and said second unit is operative to generate an excitation signal which causes said first unit to generate the signal.

39. A security system as recited in claim 20, wherein said first unit is a physical characteristic of a user and said second unit comprises a biometric sensor.
